(19) United States
(12) Patent Application Publication
(10) Pub. No.: US 2012/0273160 A1
(43) Pub. Date: Nov. 1, 2012

(54) HVAC SYSTEM

(76) Inventors: Christoph HIPP-KALTHOFF, Simmozhein (DE); Stefan WINKELMANN, Bietigheim-Bissingen (DE); Suse Schmidt-Winkelmann, Bietigheim-Bissingen (DE); Versamis VENETIDIS, Kornwestheim (DE)

(21) Appl. No.: 13/426,990

(22) Filed: Mar. 22, 2012

Related U.S. Application Data
(63) Continuation of application No. PCT/EP2010/063152, filed on Sep. 8, 2010.

(30) Foreign Application Priority Data
Sep. 22, 2009 (DE) 10 2009 042 269.2

(51) Int. Cl. B60H 1/00

(52) U.S. Cl. 165/42; 454/143

(57) ABSTRACT

An HVAC system for a construction vehicle is provided that includes a housing, a blower for circulating the air, at least one air duct for conveying the air, a coolant evaporator for cooling the air passed through the coolant evaporator, a heater for heating the air passed through the heater, a fresh air inlet opening, and a recirculating air inlet opening. The blower, the heater, and the coolant evaporator are disposed one above the other, so that only the blower or only the heater or only the coolant evaporator is cut through in a horizontal section, and/or the fresh air inlet opening and the recirculating air inlet opening are constantly open, so that exclusively fresh air and recirculating air is drawn in substantially simultaneously by the blower.

This nonprovisional application is a continuation of International Application No. PCT/EP2010/063152, which was filed on Sep. 8, 2010, and which claims priority to German Patent Application No. DE 10 2009 042 269.2, which was filed in Germany on Sep. 22, 2009, and which are both herein incorporated by reference.

### BACKGROUND OF THE INVENTION

1. Field of the Invention

The invention relates to an HVAC system and to a method for operating an HVAC system.

2. Description of the Background Art

HVAC systems are used to heat and/or cool air supplied to the interior of a motor vehicle. An HVAC system comprises a coolant evaporator, a condenser, and a compressor. The coolant evaporator, the condenser, and the compressor are connected by means of lines to a coolant circuit. The coolant evaporator is disposed in a housing of the HVAC system and is used to cool the air to be supplied to the interior of the motor vehicle.

Further, a blower and a heater are disposed in the housing of the HVAC system. Air is drawn in by the blower through a fresh air inlet opening and a recirculating air inlet opening and then cooled in the coolant evaporator and heated in the heater. The compressor and the condenser in this case, which includes construction vehicles, are positioned outside the housing, for example, in the area of an engine compartment. The housing of the HVAC system with the blower, the heater, and the coolant evaporator when used in construction vehicles, for example, in a mini excavator, is disposed within a vehicle cabin of the construction vehicle, whereby the user of the construction vehicle can come in direct contact with the housing. In passenger vehicles, said housing is generally installed in the instrument panel. For this reason, there should be special requirements for HVAC systems in construction vehicles; for example, no condensation water may form on the outside of the housing of the HVAC system at cold spots and, in other respects, hot spots may also not occur in the area of the heater on the housing of the HVAC system; i.e., it should be possible to touch the housing by hand without burns or injury occurring. Further, the HVAC system should be made robust to mechanical stress.

DE 10 2004 061 922 A1 shows an air conditioning unit for a vehicle with a passenger compartment, an engine section, and a partition wall, which separates the passenger compartment from the engine section. The air conditioning system in this case is disposed within the passenger compartment near the partition wall for cooling or heating the air. The air conditioner is provided with a blower, a heater, and an evaporator.

U.S. Pat. No. 6,958,009 B2 shows an air conditioner for a motor vehicle with a blower fan, a heater, and a coolant evaporator. The air conditioner further has an outlet opening for defrosting and a fresh air inlet opening, as well as a recirculating air inlet opening.

EP 1 090 784 B1, which corresponds to U.S. Pat. No. 6,431,257, discloses an air conditioning apparatus for a vehicle with a housing, a blower fan, a cooling heat exchanger, and a heating heat exchanger. Based on the structural design of the air conditioning apparatus, a use, for example, within a driver's cab of a construction vehicle is associated with considerable disadvantages.

### SUMMARY OF THE INVENTION

It is therefore an object of the present invention to provide an HVAC system and a method for operating an HVAC system, in which the housing has compact dimensions, particularly for arrangement in a driver's cab of a construction vehicle, e.g., a mini excavator, and the air flow within the housing assures reliable operation of the HVAC system.

The object is attained in an embodiment with an HVAC system, particularly for a construction vehicle, comprising a housing, a blower for circulating the air, at least one air duct for conveying air, a coolant evaporator for cooling the air passed through the coolant evaporator, a heater for heating the air passed through the heater, preferably a fresh air inlet opening, and preferably a recirculating air inlet opening, whereby the blower, the heater, and the coolant evaporator are disposed one above the other, so that preferably only the blower or only the heater or only the coolant evaporator is cut through in a horizontal section, and/or the fresh air inlet opening and the recirculating air inlet opening are constantly open, so that exclusively fresh air and recirculating air can be drawn in simultaneously by the blower, and/or the blower is disposed above the heater and the heater is disposed above the coolant evaporator, and a vertical evaporator air duct, leading from the blower to the coolant evaporator, has a heater wall, which prevents the flow of air into the heater.

Because of disposing the blower, the heater, and the coolant evaporator above one another, the housing of the HVAC system has only a small expansion in the horizontal direction and a much greater expansion in the vertical direction. As a result, the arrangement of the HVAC system within a driver's cab can be easily realized. In addition, in an advantageous manner because of the arrangement of the blower at an upper end region of the housing, the fresh air inlet opening and the recirculating air inlet opening can also be arranged at the upper end region of the housing with short air paths, so that the risk of entering dirt in the fresh air inlet opening and in the recirculating air inlet opening can be reduced, because dirt generally occurs more extensively at the bottom. Because the fresh air inlet opening and the recirculating air inlet opening are constantly open, no additional air flap is needed to control whether fresh air or recirculating air is drawn in. As a result, the HVAC system can be designed especially simply, inexpensively, and reliably.

In particular, the blower is disposed above the heater and/or the heater is disposed above the coolant evaporator and/or the fresh air inlet opening and the recirculating air inlet opening are disposed above the blower.

In another design, an air filter is disposed in the air flow direction upstream of the blower. The air filter in this case filters both the fresh air and also the recirculating air. As a result, the blower and all other devices connected to the blower are protected from dirt. Because of the arrangement of the blower in the upper end region and of the air filter likewise in the upper end region above the blower, most of the HVAC system is protected from dirt by the air filter.

In an additional embodiment, an air filter is disposed in the air flow direction upstream and downstream of the blower.

In an additional design, an air filter is disposed in the air flow direction downstream of the blower. Said air filter, e.g., a particle filter, protects the upper part of the HVAC system from possible wear by the blower motor such as, for example, copper.

Because of the arrangement of the blower in the upper end region of the HVAC system, the entire area, which in terms of flow is arranged downstream of the blower, is at an excess pressure, so that because of the excess pressure no dirt can enter the HVAC system due to leaks in the housing.

In a supplementary embodiment, the air filter is disposed, particularly exclusively, above the blower.

The blower is disposed in an intake chamber, and the fresh air inlet opening and the recirculating air inlet opening open into the intake chamber, and preferably the intake chamber is divided horizontally by the air filter into an upper intake subchamber and a lower intake subchamber, and preferably the fresh air inlet opening and/or the recirculating air inlet opening open into the upper intake subchamber, and the blower in particular is disposed in the lower intake subchamber. In an advantageous way, therefore, soiling occurs only in the much smaller upper intake subchamber and therefore only filtered air occurs in the lower intake subchamber and the downstream air-conducting units, which make up the majority of the HVAC system, so that thereby no soiling can occur in most parts of the HVAC system because of the filtered air.

In a variant, the evaporator air duct is oriented substantially vertically, for example, with a deviation of less than 30°, 20°, or 10° relative to a vertical, so that the air flows downward substantially vertically from the blower to the coolant evaporator.

Expediently, a heater air duct, leading from the coolant evaporator to the heater, is oriented substantially vertically, i.e., with a deviation of less than 30°, 20°, or 10° relative to a vertical, so that the air flows substantially vertically upward from the coolant evaporator to the heater. Because of the vertical orientation of the evaporator air duct and of the heater air duct, the housing of the HVAC system advantageously has a substantially smaller extent in the horizontal direction than in the vertical direction.

In another embodiment, the air flowing out of the heater is separated by the heater wall from the evaporator air duct.

In particular, the housing comprises an outer housing and an inner housing and the coolant evaporator and/or the heater are attached, particularly exclusively, to the inner housing.

In another design, the inner housing has an inexpensive plastic, e.g., a thermoplastic plastic such as polypropylene.

The outer housing have a high-grade plastic, e.g., a mixed material of a thermoplastic plastic such as acrylonitrile-butadiene-styrene (ABS) and polycarbonate (PC). The outer housing must withstand the high mechanical stress and for this reason is to be fabricated from a high-grade plastic. As a departure from this, the outer housing can be fabricated from metal, e.g., sheet metal.

In another design, the outer housing and/or the inner housing are made of many parts. In another design, the inner housing has a lower inner housing and an upper inner housing.

In an additional design, the lower inner housing, particularly with the coolant evaporator attached thereto, is designed as a pot, which has at least one drain for the forming condensate. The condensation water accumulating in the coolant evaporator can thereby also leave the pot during strong inclinations of the driver's cab of the construction vehicle, for example, an inclination and/or tilt angle in the range of 30° to 50°. At the at least one outlet opening of the lower inner housing, therefore, the condensation water can be discharged in a controlled manner outward out of the construction vehicle by suitable draining devices.

In an additional design, the fresh air inlet opening and/or the recirculating air inlet opening are disposed in the upper end region of the housing of the HVAC system, particularly in the topmost 50%, 30%, or 10% of the vertical overall extent of the housing of the HVAC system.

In another design, the coolant evaporator and/or the heater are attached to the inner housing.

In another embodiment, the inner housing is disposed at a distance to the outer housing, so that an isolation space forms between the inner housing and the outer housing. As a result, no cold surfaces with the risk of condensation water formation occur on the outer side, i.e., on the outer housing in the area of the coolant evaporator, and no warm or hot surfaces, which pose the danger of injuries, in the area of the heater on the outer housing.

In an additional design, a bottom wall of the driver's cab forms a bottom wall of the outer housing and/or a back wall of the driver's cab forms a back wall of the outer housing.

In a variant, the walls of the evaporator air duct in the area of the heater are formed by the inner housing and/or the outer housing.

The method of the invention for operating an HVAC system, particularly an HVAC system described in this industrial property application, comprises the steps: drawing in of air by means of a blower, passing the air through a coolant evaporator so that preferably the air is cooled, passing the air through a heater so that preferably the air is heated, and discharging the air out of the HVAC system, whereby the air is drawn in constantly and simultaneously from a fresh air inlet opening and a recirculating air inlet opening, and/or the air leaving the blower is directed in an evaporator air duct substantially vertically downward to the coolant evaporator and in so doing is directed past the heater preferably in a section of the evaporator air duct, and/or the air flows substantially horizontally through the coolant evaporator, and/or the air flows through the heater substantially horizontally, and/or the air leaving the coolant evaporator is directed in a heater air duct substantially vertically upward to the heater.

In another design, the air flowing in through the fresh air inlet opening and the recirculating air inlet opening is passed through a filter before being supplied to the blower. The blower and the devices downstream from the blower in the HVAC system are thereby protected from soiling in an advantageous manner.

In a supplementary variant, the air flowing out of the heater is diverted, so that the horizontal directional component of the air flowing through the heater is changed by at least 45° or 90°.

In a supplementary variant, after the diverting the air is discharged from the housing of the HVAC system. After the discharging of the air from the HVAC system, the discharged air is generally fed in a controlled manner through suitable air ducts into the driver's cab of the construction vehicle.

In another design, the air is diverted and divided into two partial streams, so that the air is discharged out of the housing, preferably on the sides, from two separate outlet openings.

In an additional design, the air is diverted substantially by 90° before flowing into the coolant evaporator and/or after flowing out of the coolant evaporator, so that the air before flowing in is diverted from a vertical downward directed flow direction to a horizontal flow direction and/or after flowing out of the coolant evaporator is diverted from a horizontal flow direction to a vertical upwardly directed flow direction.

In another design, the at least one outlet opening of the HVAC system is formed in a middle vertical section of the housing, particularly in the middle 50% of the vertical extent of the housing of the HVAC system.

Expediently, the HVAC system comprises a coolant condenser, a compressor, and lines for a coolant circuit.

In an additional design, the HVAC system comprises a control unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein

FIG. 1 is an oblique view of an HVAC system from the back with an inner housing and an outer housing;

FIG. 2 is an oblique view of the HVAC system according to FIG. 1 from the front with a coolant evaporator and a heater;

FIG. 3 is an oblique view of the HVAC system according to FIG. 1 from the back with the coolant evaporator and the heater; and

FIG. 4 is a vertical cross section of the HVAC system according to FIG. 1.

### DETAILED DESCRIPTION

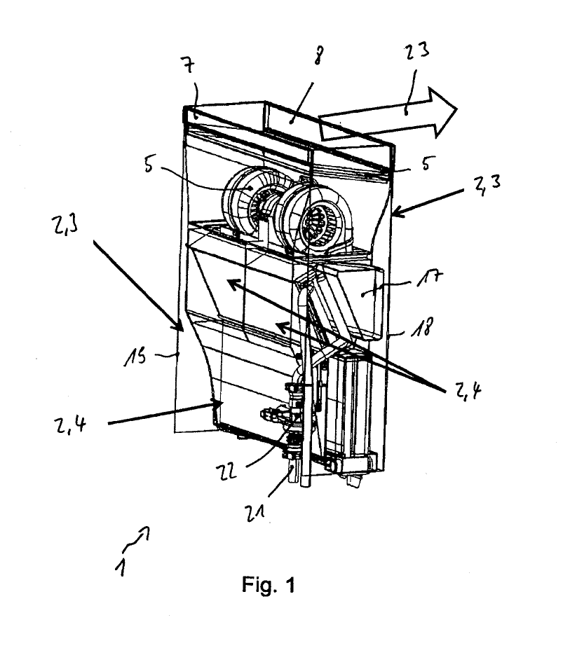

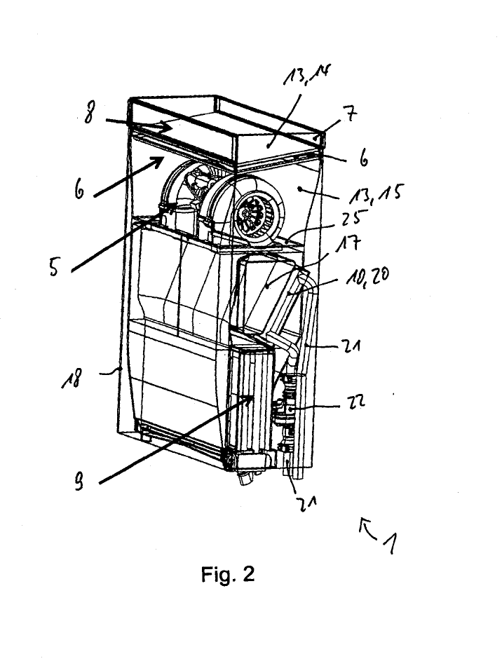

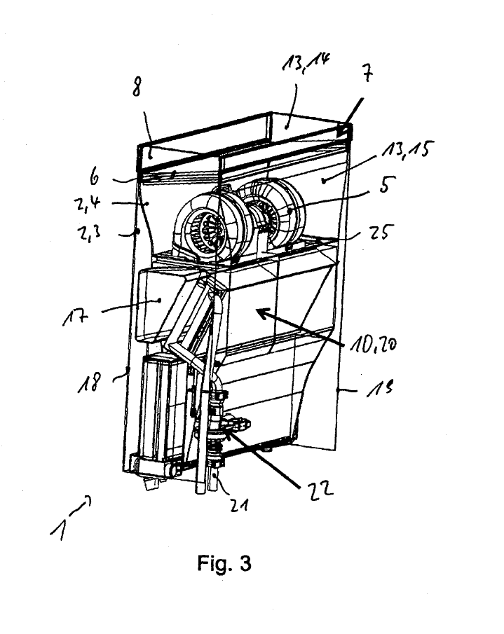

The HVAC system 1 shown in FIGS. 1 to 4 is used for cooling and/or heating of air for a construction vehicle, e.g., a mini excavator. HVAC system 1 in this case is disposed within a driver's cab of the construction vehicle. HVAC system 1 for this reason has compact dimensions and the vertical extent of HVAC system 1 is substantially greater than the horizontal extent of HVAC system 1, so that HVAC system 1 can be readily positioned and disposed in an advantageous manner, for example, on the back wall of the driver's cab within the driver's cab (not shown).

HVAC system 1 comprises a housing 2 with an outer housing 3 and an inner housing 4. Housing 4 in this case is formed of plastic and the outer housing in this case of a higher grade plastic than inner housing 4. This is necessary, because greater mechanical stress occurs on outer housing 3, e.g., by the striking of objects on outer housing 3. Polypropylene as a thermoplastic plastic is used, for example, as a material for the inner housing and a mixture of acrylonitrile-butadiene-styrene (ABS) and polycarbonate (PC) as a thermoplastic for the outer housing. Inner housing 4 in this case is disposed at a distance from outer housing 3, and a coolant evaporator 9 and a heater 10 are attached to inner housing 4. Heater 10 in this case is a heat exchanger 20, through which coolant from an internal combustion engine of the construction vehicle is passed by means of a coolant line 21. A control valve 22 in this case controls the amount of coolant passed through heat exchanger 20 and thereby heater 10. In this way, whether and how greatly the air passed through heater 10 is heated can be controlled by means of control valve 22. Because of the distance between inner housing 4 and outer housing 3, an insulation layer of air forms between inner housing 4 and outer housing 3, so that no condensation water formation occurs on outer housing 3 in the area of coolant evaporator 9 and also no sections with a greatly increased temperature occur on outer housing 3 in the area of heater 10. Heater 10 is used to heat the air and coolant evaporator 9 is used to cool the air passed through HVAC system 1.

Housing 2 in the upper end region has a fresh air inlet opening 7 and a recirculating air inlet opening 8. The recirculating air inlet opening 8 in this case is designed as a front side 18 of HVAC system 1. Front side 18 is oriented toward a driving direction 23 of the construction vehicle. Back side 19 is opposite to front side 18 of HVAC system 1 (FIG. 1). Front side 18 of HVAC system 1 is thus disposed in the area of the interior space of the driver's cab of the construction vehicle and back side 19 of the HVAC system in the area of a back wall of the driver's cab of the construction vehicle (not shown). Thus, fresh air can be drawn in at fresh air inlet opening 7 from the area surrounding the construction vehicle through an opening or a duct in the back wall of the driver's cab and air can be drawn in from the interior of the driver's cab of the construction vehicle from the recirculating air inlet opening 8. A blower 5 with an electric motor and two impellers with blades, driven by the electric motor, is disposed in this case within an intake chamber 13. Intake chamber 13 in this case is divided by a substantially horizontally oriented air filter 6 into an upper intake subchamber 14 and a lower intake subchamber 15. Blower 5 is disposed in the lower intake subchamber 15. Air filter 6 in this case is oriented with a deviation of less than 30°, 20°, or 10° to the horizontal. Fresh air inlet opening 7 and recirculating air inlet opening 8 open into the upper intake subchamber 14. After the air flows in through fresh air inlet opening 7 and recirculating air inlet opening 8, the air is filtered by air filter 6 and then enters downward through air filter 6 into lower intake subchamber 15. As a result, dirt, which enters through fresh air inlet opening 7 and recirculating air inlet opening 8 into HVAC system 1, is retained by air filter 6, so that soiling can occur only in the small section of HVAC system 1, namely, in the upper intake subchamber 14. The entire area of HVAC system 1, said area disposed below air filter 6, is thus supplied with filtered air, so that thereby in an especially advantageous manner no soiling can occur in most of HVAC system 1 and damage resulting therefrom can be avoided.

The lower intake subchamber 15 is bounded on the side walls by inner housing 4, on the top side by air filter 6, and on the bottom side by an intake chamber bottom wall 25. Blower 5 is attached to intake chamber bottom wall 25 as part of inner housing 4. Intake chamber bottom wall 25 in this case has two blower openings 26, through which the air drawn in by blower 5 is introduced into evaporator air duct 11. Evaporator air duct 11 is oriented substantially vertically, i.e., oriented with a deviation of less than 30°, 20°, or 10° to the vertical. The air here flows vertically downward from the two blower openings 26 past heater 10 to coolant evaporator 9. A heater wall 12 as part of a wall bounding evaporator air duct 11 in this case prevents the air flowing downward from blower openings 26 from entering heater 10. The air flowing downward in evaporator air duct 11 in this case is diverted in the area of coolant evaporator 9 substantially by 90°, i.e., in the range between 120° and 60°, and then flows in a substantially horizontal direction through coolant evaporator 9. Because of the flow of the air through coolant evaporator 9 in a substantially horizontal direction, i.e., with a deviation of less than 30°, 20°, or 10° to the horizontal, the air thereby flows from the front side 18 of HVAC system 1 in the direction to back side 19 of HVAC system 1. After the air leaves coolant evaporator 9, the air is again diverted upward substantially by 90°, i.e., with a deviation of less than 30°, 20°, or 10° to the diversion of 90°, so that the air then flows upward substantially vertically into a heater air duct 16, formed by inner housing 4. Flowing upward substantially vertically means that the air flows upward to heater 10 with a deviation of less than 30°, 20°, or 10° to the vertical.

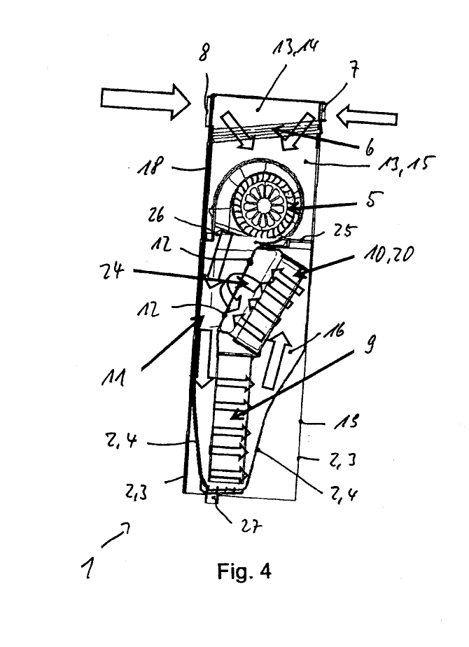

In the entry region of heater 10, the air flowing upward through heater air duct 16 is diverted substantially by 90°, i.e., with a deviation of 30°, 20°, or 10° relative to 90°, so that the air flows substantially horizontal through heater 10 and thereby flows from back side 19 of HVAC system 1 to front side 18 of HVAC system 1. A substantially horizontal flow through heater 10 means that the air flows through heater 10 with a deviation of less than 45°, 30°, or 10° relative to the horizontal. After flowing out of heater 10, the air flows into a discharge space 24. Discharge space 24 in this case is bounded in the horizontal direction on the one side by heater wall 12 and on the other by heater 10. Perpendicular to the plane of the drawing of FIG. 4, in this case an outlet opening 17 is disposed in each case on the side in HVAC system 1. The air flowing out through heater 10 is thus diverted by approximately 90° and thus then flows to the two side outlet openings 17 on housing 2. The two outlet openings 17 emerging on the sides on housing 2 are connected to air guiding ducts (not shown) within the driver's cab of the construction vehicle. The air is then introduced through these in a controlled manner into the interior of the driver's cab (not shown). The entire area of HVAC system 1, said area formed below the intake chamber bottom wall 25, i.e., particularly heater 10, coolant evaporator 9, evaporator air duct 11, and heater air duct 16 are here at excess pressure, so that in the case of leaks or leakage at housing 2 because of said excess pressure advantageously no dirt can enter the interior of HVAC system 1.

Inner housing 4 has a lower inner housing 4 in which coolant evaporator 9 is disposed. Said lower inner housing 4 is designed in this case in the shape of a pot and has condensation water discharge openings 27 on a bottom side 2. Because of said pot shape of lower inner housing 4, no uncontrolled discharge of condensation water from HVAC system 1 not occur, even with great inclinations of the construction vehicle, e.g., an inclination in the range of 30° to 50° relative to the horizontal. All of the condensation water forming in coolant evaporator 9 thus flows through the two condensation water discharge openings 27 out of housing 2 of HVAC system 1. Connecting lines (not shown), which take the condensation water in a controlled manner out of the driver's cab of the construction vehicle, are disposed at the condensation water discharge openings 27.

Regarded overall, major advantages are associated with HVAC system 1 of the invention. Housing 2 of HVAC system 1 has a much greater expansion in the vertical direction than in the horizontal direction, so that HVAC system 1 can be easily disposed within a driver's cab of a construction vehicle. Costly and failure-prone air flaps for controlling the fresh air inlet and recirculating air inlet are not needed and incoming dirt is already deposited on air filter 6 disposed very far above within housing 2, so that thereby most of HVAC system 1 is supplied with filtered and therefore clean air, so that malfunctions and damage, caused thereby, can be substantially avoided in HVAC system 1. In addition, condensation water formation and areas with a greatly increased temperature on outer housing 3 can be avoided and incoming dirt due to leakages in the housing can be ruled out further below intake chamber bottom wall 25 due to the predominating excess pressure.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An HVAC system for a construction vehicle, the system comprising:
a housing;
a blower for circulating the air;
at least one air duct for conveying the air;
a coolant evaporator for cooling the air passed through the coolant evaporator;
a heater for heating the air passed through the heater;
a fresh air inlet opening; and
a recirculating air inlet opening,
wherein the blower, the heater, and the coolant evaporator are disposed one above the other, so that only the blower or only the heater or only the coolant evaporator is cut through in a horizontal section, and/or the fresh air inlet opening and the recirculating air inlet opening are constantly open, so that exclusively fresh air and recirculating air is drawn in substantially simultaneously by the blower, and/or the blower is disposed above the heater, and the heater is disposed above the coolant evaporator, and a vertical evaporator air duct, leading from the blower to the coolant evaporator, has a heater wall, which prevents the flow of air into the heater.

2. The HVAC system according to claim 1, wherein the blower is disposed above the heater, and/or the heater is disposed above the coolant evaporator, and/or the fresh air inlet opening and the recirculating air inlet opening are disposed above the blower.

3. The HVAC system according to claim 1, wherein an air filter is disposed in the air flow direction upstream of the blower.

4. The HVAC system according to claim 3, wherein the air filter is disposed above the blower.

5. The HVAC system according to claim 1, wherein the blower is disposed in an intake chamber, and the fresh air inlet opening and the recirculating air inlet opening open into the intake chamber, and the intake chamber is divided horizontally by the air filter into an upper intake subchamber and a lower intake subchamber, and the fresh air inlet opening and/or the recirculating air inlet opening open into the upper intake subchamber, and the blower is disposed in the lower intake subchamber.

6. The HVAC system according to claim 1, wherein the evaporator air duct is oriented substantially vertically, so that the air flows downward substantially vertically from the blower to the coolant evaporator.

7. The HVAC system according to claim 1, wherein a heater air duct, leading from the coolant evaporator to the heater is oriented substantially vertically so that the air flows substantially vertically upward from the coolant evaporator to the heater.

8. The HVAC system according to claim 1, wherein air flowing out of the heater is separated by the heater wall from the evaporator air duct.

9. The HVAC system according to claim 1, wherein the housing comprises an outer housing and an inner housing and the coolant evaporator and/or the heater are attached to the inner housing.

10. A method for operating an HVAC system according to claim 1, the method comprising:
drawing in air via a blower;
passing the air through a coolant evaporator so that the air is cooled;
passing the air through a heater so that the air is heated; and
discharging the air out of the HVAC system;
wherein the air is drawn in constantly and substantially simultaneously from a fresh air inlet opening and a recirculating air inlet opening, and/or the air leaving the blower is directed to an evaporator air duct substantially vertically downward to the coolant evaporator and in so doing is directed past the heater in a section of the evaporator air duct and/or the air flows substantially horizontally through the coolant evaporator, and/or the air flows through the heater substantially horizontally, and/or the air leaving the coolant evaporator is directed in a heater air duct substantially vertically upward to the heater.

11. The method according to claim 10, wherein the air flowing in through the fresh air inlet opening and the recirculating air inlet opening is passed through a filter before being supplied to the blower.

12. The method according to claim 10 wherein the air flowing out of the heater is diverted so that the horizontal direction component of the air flowing through the heater is changed by at least 45° or 90°.

13. The method according to claim 12, wherein after the diversion the air is discharged from the housing of the HVAC system.

14. The method according to claim 12, wherein the air is diverted and divided into two partial streams so that the air is discharged out of the housing on the sides from two separate outlet openings.

15. The method according to claim 10, wherein the air is diverted substantially by 90° before flowing into the coolant evaporator and/or after flowing out of the coolant evaporator so that the air before flowing in is diverted from a vertical downward directed flow direction to a horizontal flow direction and/or after flowing out of the coolant evaporator is diverted from a horizontal flow direction to a vertical upwardly directed flow direction.
